(19) United States
(12) Patent Application Publication
(10) Pub. No.: US 2006/0095325 A1
(43) Pub. Date: May 4, 2006

(54) Method and system for tracking purchasing habits

(76) Inventors: Kevin H. Bell, Raleigh, NC (US); Nathan C. Clark, Topeka, KS (US); Boyd K. Dimmock, Raleigh, NC (US); John S. Graham, Raleigh, NC (US); James L. Griesedieck, Raleigh, NC (US); Ameet A. Kulkarni, Woburn, MA (US); Kris Prasad, Cary, NC (US); Thomas J. Sluchak, Apex, NC (US)

Correspondence Address: SAWYER LAW GROUP LLP, PO BOX 51418, PALO ALTO, CA, 94303, US

(21) Appl. No.: 10/982,737

(22) Filed: Nov. 4, 2004

(51) Int. Cl. G06Q 30/00; G06F 17/30

(52) U.S. Cl. 705/14; 705/10

(57) ABSTRACT

A system and method for tracking purchasing habits includes receiving in a computer system for a store, a shopping list including a product. The shopping list comes from a consumer and is independent of an inventory for the store. The store records a purchase by the consumer and compares the purchase to the product on the shopping list.

### FIELD OF THE INVENTION

The present invention relates generally to gathering information and specifically to tracking purchasing habits.

### BACKGROUND OF THE INVENTION

Retailers today have no means of finding out reasons related to the purchasing behavior patterns of their consumers. For example, a consumer may arrive at a grocery store with a shopping list containing several items. Several different scenarios may occur: the consumer may purchase an item which is not on the list; the consumer purchases a item on the list, but under a different brand; the consumer buys an item from a different location; or the consumer does not buy the item.

Retailers do not know the motivations or intentions behind their consumers' purchase decisions. Broadly speaking, a consumer may belong to one or more of these categories: budget oriented; thrifty; brand cautious; trying new varieties of brands; discount seeking; or a habit shopper who typically purchases the same product.

One problem retailers have is knowing what a consumer is looking for, rather than simply what they purchase. If a retailer can understand what a consumer wants in addition to what the consumer buys, then the retailer can provide a better shopping experience for the consumer by giving them what they want, therefore increasing profitability for the retailer and strengthening the long-term relationship between the retailer and the consumer.

Accordingly, a need exists for a system and method for tracking purchasing habits.

### SUMMARY OF THE INVENTION

A method and system for tracking purchasing habits of a consumer is described. The method and system include receiving in a computer system for a store, a shopping list including a product. The shopping list comes from the consumer and is independent of an inventory for the store. The store records a purchase by the consumer and compares the purchase to the product. By comparing what the consumer intended to buy with what the consumer actually bought, the retailer may determine what motivates the consumer, what they are actually looking for (rather than settling for), and how to better sell to the consumer. Moreover, by analyzing the consumer's buying habits over a period of time, the retailer can better serve the consumer.

The advantages of the present invention include increasing profitability for a retailer and strengthening the relationship between a consumer and a retailer by improving the shopping experience for the consumer.

### BRIEF DESCRIPTION OF THE DRAWINGS

FIG. 1 is a block diagram illustrating one embodiment of the invention with an electronic device and a computer system.

FIG. 2 is a block diagram illustrating one embodiment of implementing a method of the invention with the electronic device and computer system of FIG. 1.

### DETAILED DESCRIPTION

The present invention relates generally to gathering information and specifically to tracking the purchasing habits of a consumer. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

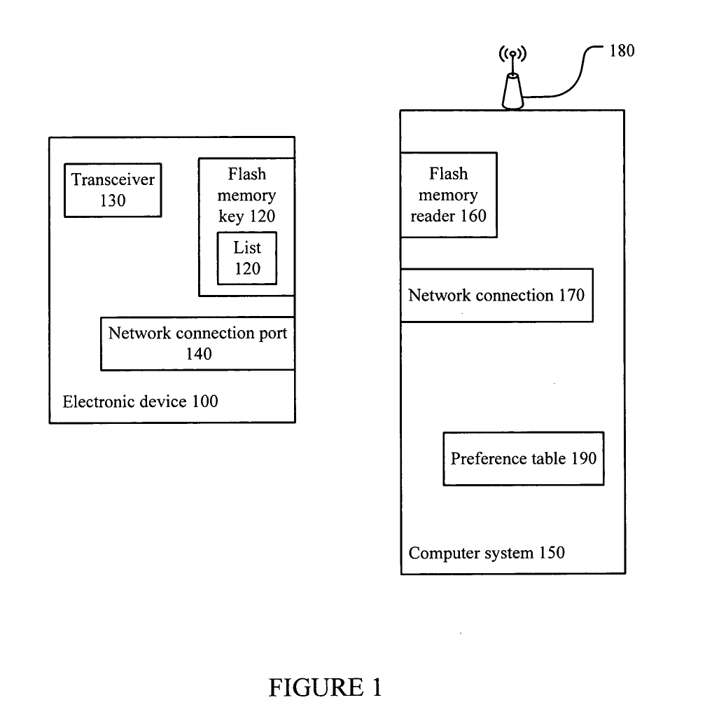

FIG. 1 is a block diagram illustrating one embodiment of the invention. An electronic device 100 may be any device capable of generating or receiving a shopping list 110, for example a personal computer (PC), a tablet, a personal digital assistant (PDA), a cell phone, etc. The electronic device 100 may include a memory, for example a removable flash memory key 120, a transceiver 130, and a network connection port 140. The electronic device may also include a processor and other parts that are not illustrated in FIG. 1.

The electronic device 100 may be used by a consumer to generate the shopping list 110 or may receive the list 110 from another source. In one embodiment, the list 110 may be generated on a PC (not shown), transferred to the electronic device 100 (a PDA, for example), and taken to the store by the consumer, where the electronic device 100 communicates through transceiver 130 using a wireless technology such as BLUETOOTH or infra-red (IR). In another embodiment, the list may be generated on the electronic device 100, for example a PC, then transferred to the flash memory key 120, which may be removed and taken to the store by the consumer.

The shopping list (list) 110 may include products that the consumer intends to purchase, for example “frozen pizza” and “HAGEN DAAZ ice cream.” The shopping list may be in a number of formats, for example, extensible markup language (XML), rich text format (RTF), and WORDPERFECT. The shopping list may be generated using a word processing program or spreadsheet typically used by the consumer, for example, or may be created in conjunction with a store-supplied list of options (through the Internet or a downloaded program from the store i.e. some kind of user interface that allows the consumer to enter details like the product name, quantity etc.). The list is not limited to items sold at or in inventory at the store. Furthermore, the invention addresses consumer concerns about security or privacy by maintaining control of the list 110 by the consumer and opting to share (or not to share) the list 110 with the store.

At the retail store to which the consumer is going, for example a grocery store, there is a computer system 150 that may include a flash memory reader 160, a network connection port 170, and a wireless link 180. Additionally, the computer system 150 may include a processor, storage, and may function as a server or be linked to a server. In one embodiment, the computer system 150 may be in a kiosk at one or more parts of the store, or it may be integrated into a shopping cart. In another embodiment, the computer system 150 is a server that receives through network connection port 170 the list 110 via the Internet. In yet another embodiment, the computer system 150 receives the list 110 through wireless link 180 and identifies the list as belonging to the consumer with a unique identification tag, for example.

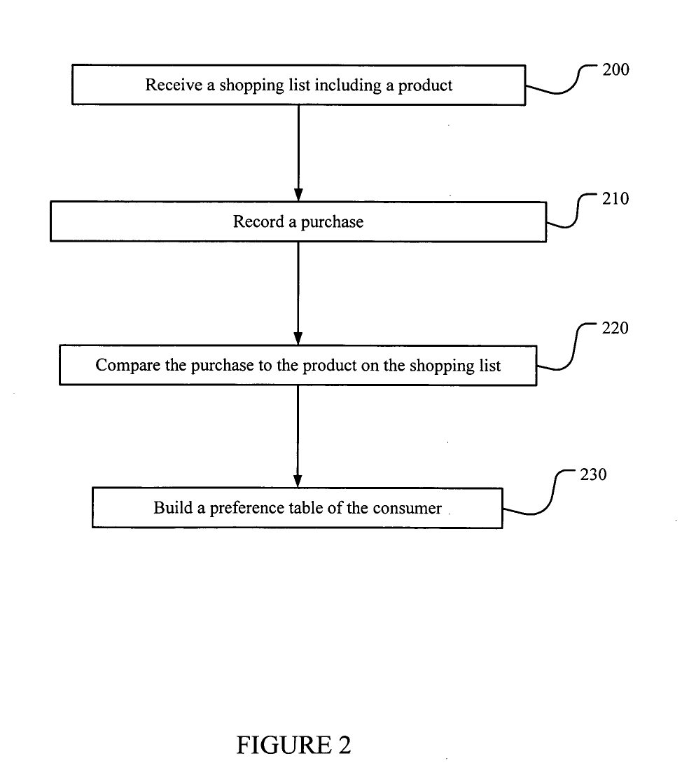

FIG. 2 is a block diagram illustrating one embodiment of implementing a method of the invention with the electronic device and computer system of FIG. 1. Upon arrival at a store the consumer has the option of sharing the list with the store, for example through the flash memory key 120, a transceiver 130, or linked to the Internet through network connection 140 (including, for example, a satellite uplink). In block 200, the store receives the shopping list 110, including the products on the list: frozen pizza and HAGEN DAAZ ice cream, in this example. Computer system 150 may receive the list through the flash memory reader 160, through the wireless link 180, or through the network connection 170.

The consumer decides to purchase, for example, TOMBSTONE frozen pizza and DAIRY QUEEN ice cream. At checkout, in block 210, the store records the purchase of the pizza and ice cream, either through communication with computer system 150 or through shopping cards associated with conventional systems and identifying the consumer in such a manner so as to link them with the list 110.

In block 220, the computer system 150 may compare the purchase to the product from the list 110. Continuing with the above example, the computer system would compare “TOMBSTONE frozen pizza” with “frozen pizza” and “HAGEN DAAZ ice cream” with “DAIRY QUEEN ice cream.”

Based on the comparison, in block 230 the computer system 150 may build a preference table 190 of the consumer (the preference table 190 may be built elsewhere as well). The preference table 190 could include, for example, information that the consumer buys HAGEN DAAZ ice cream unless DAIRY QUEEN ice cream is on sale or the consumer has a coupon, or that if HAGEN DAAZ is out of stock then DAIRY QUEEN is a suitable replacement, although if neither is in the consumer will not buy ice cream at all. The preference table 190 could include information that the consumer always buys the least expensive frozen pizza, and will buy TV dinners as an alternative to frozen pizza when TV dinners are on sale or the consumer has a coupon for them. The preference table 190 is built from a combination of the consumer-generated list 110 and the purchases actually made, therefore indicating what the consumer bought given the consumer's preferences and intentions. The preference table 190 is open to algorithms, data mining techniques for analysis and searching for trends and patterns, and may be taken by the consumer through flash memory key 120, wireless link 180, or network connection 170 for example, to other stores and even competitors. In this manner, although a consumer may primarily shop at SAFEWAY, the consumer may take the preference table 190 (transferred to them in the flash memory key 120, for example) to TRADER JOE'S, and gain benefits from the preference table 190 at TRADER JOE'S. Preference table 190 may include, for example, the information that the consumer prefers the lowest price frozen pizza to TV dinners, and will buy more frozen pizzas at a given price than TV dinners, so TRADER JOE'S may offer a coupon to the consumer for that visit that brings the frozen pizza down to the price of the most expensive TV dinner. In this manner the consumer may benefit from the preference table 190 and its portability. The preference table can also help the retailer in promoting up-sale of the products. For example, the retailer may find that the consumer always buys chips, so then the retailer can promote salsa/dip with the chips at a discounted price. This kind of bargain benefits both the consumer and retailer. Similar discounts may be applied with bread and peanut butter/jelly, cookies and milk, hamburgers and buns, and so on.

The preference table 190 may include, for example, the list of products (from the list I 0) versus the list of actual purchases, the respective prices, discounts, coupons, frequency of purchase, and so on. The preference table 190 may be in a database or XML format, for example, and may be dynamic, changing with the consumer's changing tastes or needs (adding a member to the household, for example a child or pet, dietary restrictions in place by a physician, and so on).

The preference table 190 may be used by the store to generate a coupon that could be sent to a targeted consumer for a certain product during a certain time, for example, if the user is identified as a “coupon shopper.” The discounted coupons given by the retailer may be different for different consumers depending on the preference table associated with that consumer.

A method and system for tracking the purchasing habits of a consumer has been disclosed. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

The invention claimed is:

1. A method for tracking purchasing habits comprising:
receiving in a computer system for a store a shopping list for a consumer, wherein the shopping list includes a product and is independent of an inventory for the store;
recording a purchase from the store by the consumer; and
comparing the purchase to the product on the shopping list.

2. The method of claim 1, the shopping list including a brand name for the product, the method further comprising:
providing a preference table of the consumer, in the computer system, a brand name of the purchase and the brand name of the product.

3. The method of claim 2 further comprising:
comparing, if the purchase and the product match, the brand name of the purchase to the brand name of the product.

4. The method of claim 2 further comprising:
including in the preference table of the consumer the cost of the purchase and the cost of the product.

5. The method of claim 4 further comprising:
comparing, if the purchase and the product match, and the brand name of the product does not match the brand name of the purchase, the cost of the purchase to the cost of the product.

6. The method of claim 1 further comprising:
providing a preference table of the consumer, in the computer system, the availability in the store of the product and the availability in the store of the purchase.

7. The method of claim 6 further comprising:
comparing the availability in the store of the product to the availability in the store of the purchase.

8. The method of claim 1 further comprising:
providing a preference table of the consumer, in the computer system, a discount applied to the purchase.

9. The method of claim 8 further comprising:
comparing the cost of the purchase, with the discount, to the cost of the product.

10. The method of claim 1 further comprising:
providing a preference table of the consumer, in the computer system, a coupon applied to the purchase.

11. The method of claim 10 further comprising:
comparing the cost of the purchase, with the coupon, to the cost of the product.

12. A computer-readable medium containing program instructions for tracking purchasing habits, the program instructions comprising:
receiving in a computer system for a store a shopping list for a consumer, wherein the shopping list includes a product and is independent of an inventory for the store;
recording a purchase from the store by the consumer; and
comparing the purchase to the product on the shopping list.

13. The computer-readable medium of claim 12, the shopping list including a brand name for the product, the program instructions further comprising:
providing a preference table of the consumer, in the computer system, a brand name of the purchase and the brand name of the product.

14. The computer-readable medium of claim 13, the program instructions further comprising:
comparing, if the purchase and the product match, the brand name of the purchase to the brand name of the product.

15. The computer-readable medium of claim 13, the program instructions further comprising:
including in the preference table of the consumer the cost of the purchase and the cost of the product.

16. The computer-readable medium of claim 15, the program instructions further comprising:
comparing, if the purchase and the product match, and the brand name of the product does not match the brand name of the purchase, the cost of the purchase to the cost of the product.

17. The computer-readable medium of claim 12, the program instructions further comprising:
providing a preference table of the consumer, in the computer system, the availability in the store of the product and the availability in the store of the purchase.

18. The computer-readable medium of claim 17, the program instructions further comprising:
comparing the availability in the store of the product to the availability in the store of the purchase.

19. The computer-readable medium of claim 12, the program instructions further comprising:
providing a preference table of the consumer, in the computer system, a discount applied to the purchase.

20. The computer-readable medium of claim 19, the program instructions further comprising:
comparing the cost of the purchase, with the discount, to the cost of the product.

21. The computer-readable medium of claim 12, the program instructions further comprising:
providing a preference table of the consumer, in the computer system, a coupon applied to the purchase.

22. The computer-readable medium of claim 21, the program instructions further comprising:
comparing the cost of the purchase, with the coupon, to the cost of the product.

23. A system for tracking purchasing habits comprising:
a computer system for a store configured to receive a shopping list for a consumer including a product, wherein the shopping list is independent of an inventory for the store, the computer system further configured to record a purchase from the store by the consumer and to compare the purchase to the product on the shopping list.

24. The system of claim 23, the shopping list including a brand name for the product, the system further configured to provide in a preference table of the consumer a brand name of the purchase and the brand name of the product.

25. The system of claim 24 further configured to compare, if the purchase and the product match, the brand name of the purchase to the brand name of the product.

26. The system of claim 24 further configured to include in the preference table of the consumer the cost of the purchase and the cost of the product.

27. The system of claim 26 further configured to compare, if the purchase and the product match, and the brand name of the product does not match the brand name of the purchase, the cost of the purchase to the cost of the product.

28. The system of claim 23 further configured to provide in a preference table of the consumer the availability in the store of the product and the availability in the store of the purchase.

29. The system of claim 28 further configured to compare the availability in the store of the product to the availability in the store of the purchase.

30. The system of claim 23 further configured to provide in a preference table of the consumer a discount applied to the purchase.

31. The system of claim 30 further configured to compare the cost of the purchase, with the discount, to the cost of the product.

32. The system of claim 23 further configured to provide in a preference table of the consumer a coupon applied to the purchase.

33. The system of claim 32 further configured to compare the cost of the purchase, with the coupon, to the cost of the product.
